(19) United States
(12) Patent Application Publication
(10) Pub. No.: US 2006/0033438 A1
(43) Pub. Date: Feb. 16, 2006

(54) Coated ceramic discharge vessel for improved gas tightness

(75) Inventors: Jean-Sebastien Straetmans, Aachen (DE); Nicasuis Gerardus Tielemanus Van Gennip, Heeze (NL); Sander Nijdam, Eindhoven (NL); Christoffel Wijenberg, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/535,636

(22) PCT Filed: Nov. 18, 2003
(86) PCT No.: PCT/IB03/05201

§ 371 Date: May 20, 2005

(30) Foreign Application Priority Data
Nov. 25, 2002 (EP) 02102639.8

(51) Int. Cl. H01J 61/36; H01J 17/18; H01J 1/62; H01J 17/16

(52) U.S. Cl. 313/623; 313/624; 313/625; 313/489; 313/635

(57) ABSTRACT

The present invention relates to a discharge vessel (1) with at least one end part (2) and a discharge cavity (3), whereby the discharge vessel (1) is at least partly coated with a coating layer (4), and whereby the gas-tight bonding of the coating layer to the discharge vessel (1), to a sealant (5) and/or to an end closure member (9) is stronger compared to the direct gas-tight bonding of said sealant (5) to said end closure member (9) and/or discharge vessel (1).

The present invention relates to a high-pressure discharge lamp, such as for instance an automotive lamp used for head lighting applications, comprising a ceramic discharge vessel, which encloses a discharge cavity, and at least one end opening with at least one coating layer deposited onto it, and preferably a feed-though opening, gas tight closed by an end closure device. Said end closure device comprises at least an end closure member and connection means. More particularly, the invention relates to the design of said discharge vessel and ways to improve its lifetime.

Discharge vessels in high-pressure discharge lamps and related manufacturing processes are known from a prior art. Nevertheless, it is still necessary to provide a design of said high-pressure discharge vessel addressing the drawbacks known from said prior art as mentioned later on. Due to said high pressure filling, gas tight closing said high-pressure discharge lamp discharge vessel causes several problems. Heating said discharge vessel for gas tight sealing leads said internal filling to expand or evaporate. As a result, filling gas expansion causes a bad quality seal, and filling salts evaporation gives unexpected lamp characteristics. Said seal is then characterized in that it ends up with an irreproducible length, since expanding gas tends to push it outwards from said discharge vessel. Moreover said seal will contain defects, such as gas bubbles, leading to cracks, which weakens the seal mechanical strength, leading to leakage.

In order to prevent the expansion or evaporation of said filling, several attempts to find alternative sealing processes and designs have been made.

WO 00/67294 describes a high-pressure discharge lamp, more precisely a metal halide one, with a very small, very high-pressure filled vessel, surrounded by a gas filled outer bulb.

Said lamp has the advantage of having a discharge vessel with very compact dimensions, which makes it highly suitable for head lighting applications in motor vehicles. Thanks to the discharge vessel internal diameter, small compared to the electrode spacing, the discharge arc is sufficiently straight, and its light emitting surface sufficiently sharply limited, so that it can be used as a light source in an automotive headlamp, especially in a headlamp with a complex-shape reflector.

The drawbacks of the known lamp are however a relative loss of the initial filling while heating up said lamp's discharge vessel as gas-tight closing it. It leads to a wrong colour point setting and to colour instability. Drawbacks also comprise an irreproducible initial sealing ceramic length while gas tight closing said discharge vessel, a sealing ceramic cracking behaviour within the high lamp-operating temperature range, which leads to a leaky seal. Furthermore said discharge vessel end construction design comprise a wide clearance, between said feed-through outer surface and the ceramic plug inner wall, which leads to colour instability. These drawbacks are caused by the current sealing process, or are related to the current sealing design. Said process is actually heating far too much surface of said filled discharge vessel, and said design is leaving far too much clearance between said feed-through and said ceramic plug. Both the feed-through and the ceramic plug are furthermore made of inappropriate thermo mechanically matching materials.

U.S. Pat. No. 6,194,832 B1 describes a metal halide discharge vessel, wherein a plug—having at least four, and preferably six or more, axially arranged layers or strata of a cermet, in which the metal content of the respective layers or strata increases from the layer or stratum closest to the discharge space of the vessel outwards—is used to close off said metal halide discharge vessel tubular ends. The innermost layer or stratum is directly sintered to the ceramic discharge vessel, typically of aluminum oxide, whereas the outermost layer or stratum has a metal content of such an extend that it can be welded, and is welded to a metallic or cermet feed-through part projecting to a central opening through the respective layers or strata of the plug. The outermost layer of the plug, preferably, has at least 50%, by volume, of metal, preferably of the same material as the feed-through part, and may even be entirely of metal, to ensure a tight, easily made weld connection. The weld can be made, for example, by laser welding. It turns out, however, that since the innermost layer of the protruded plug is not connected to the feed through, and has a low metal content that does not match the coefficient of expansion of the feed-through, it leads by design either to the formation of a crevice if there is no contact, or to stress build up in the plug if there is contact, thus to a loose fit between the plug and the feed-through very close to the vessel, i.e. to a crevice as well. Obviously salts will creep in said generated loose fit, which will lead to colour instability of the lamp, and in parallel to that, to the extension of said loose fit outwards along the feed though. For very compact automotive discharge vessel operating at relatively high temperatures, moreover going through a very high number of switches, both drawbacks are critical and lead to further leakage.

It is an object of the present invention to improve the gas-tight connection of the end closure device to the discharge vessel, in order to prevent a loose fit between said parts from forming, wherein corrosive salts filing could condensate.

This issue is addressed by partly coating a discharge vessel with at least one end part and a discharge cavity, whereby at least one of said coating layer is deposited and gas-tight connected between an end part of said discharge vessel and a sealant and/or between a sealant and an end closure member.

Said layer improves the binding of the connection means, whereby the layer provides higher adhesive strength between the discharge vessel and the connection means, and/or between the connection means and the end closure device, compared to the adhesive strength between the discharge vessel and the end closure device.

Said end closure member is usually connected to said discharge vessel with a sealant in order to achieve a strong bonding between said parts. Due to different states of surface, and different expansion coefficients between said end closure member and said discharge vessel, the gas tight binding is weakened after the operated lamp has run through a series of thermal cycles. In order to improve the gas tight bond and provide a more reliable burner, at least one coating layer is deposited onto at least a part of the end parts of the discharge vessel.

This coating layer is applied onto the discharge vessel in its green state before the firing step of the discharge vessel sintering process.

Advantageously, at least one end part of the discharge vessel is at least partly coated with a layer. Said layer improves the binding of the connection means, whereby the layer provides higher adhesive strength between the discharge vessel and the connection means, and/or between the connection means and the end closure device, compared to the adhesive strength between the discharge vessel and the end closure device. Most preferably, a first layer is located between the discharge vessel and the sealant, and a second layer between the sealant and the end closure member.

Since the gas-tight bonding of the end-closure member to the discharge vessel is improved thanks to said coated layers, loose fit seals, crevices or small cracks are reduced.

In order to prevent materials from cracking, coating layers, connection means, as well as end closure members should be made of materials characterized in that they have thermal expansion coefficients matching with one another and matching with the one of the discharge vessel.

In a preferred embodiment of the present invention, any coating material, which expansion coefficient α (T) matches the expansion coefficient of a polycrystalline alumina discharge vessel of about 8·10⁻⁶ K⁻¹ can also be suitable used for the present invention. Such materials are characterized in that their expansion coefficients α (T) lie in the following range: 4·10⁻⁶ K⁻¹≦α (T)≦12·10⁻⁶ K⁻¹ for temperatures T lying in the following range: 298 K≦T≦2174 K. Most preferably, said coating material should have an expansion coefficient as close as the one of the discharge vessel as possible in order to prevent stress build up in the coating that would lead to cracks in the layer.

Therefore, the coating layer is preferably of a material selected from the group comprising for instance W, Mo, and/or Pt. Said materials have a thermal expansion coefficient lying in the range of 4·10⁻⁶ K⁻¹ to 12·10⁻⁶ K⁻¹ and are corrosion resistant towards a typical discharge vessel metal halide filling.

Sealants according to the present invention are means for gas-tight connecting at least two parts, preferably for gas-tight connecting an end closure member to a coating layer deposited onto a discharge vessel of a high-pressure burner.

Connection means according to the present invention are also means for gas-tight connecting at least two parts such as a feed-through with an end closure member.

Sealants as well as connection means in the sense of the invention comprise materials that are needed for welding, laser welding, resistance welding, soldering, brazing, bonding with adhesive materials, primary shaping, sintering, sealing or any combination thereof.

The discharge vessel comprises end parts and a discharge cavity. The end part is preferably in the form of a protruded plug. Said discharge vessel is usually closed by end closure devices, coated with at least one layer, whereby said end closure devices are gas-tight connected to the end parts of the discharge vessel in order to provide a gas-tight high-pressure burner.

In a preferred embodiment of the present invention a burner comprises at least one end closure device, comprising at least one connection means, gas tight connecting the feed-through to the discharge vessel.

The end closure device is gas-tight connected to the discharge vessel with at least one coating layer and at least one sealant.

It has been found that corrosion problems, caused by a crevice or cracks in the coating layer, seal and/or connection means between the discharge vessel and the end closure member, can be attenuated or avoided when the outer cross-section of the end closure device feed-through-opening is ≧than the inner cross-section of the end closure device feed-through-opening. Such a feed-through-opening geometry enables a gas tight connection of the feed-through within the end closure member, located at the innermost feed-through-opening section of the end closure member facing the discharge vessel.

The end closure member feed-through entry-opening cross-section is preferably designed to be larger than the end closure member feed-through exit-opening cross-section. Furthermore, said cross sections have preferably the same geometry. The feed-through cross-section varies along the burner's main symmetry axis. The nearer the feed-through-opening cross-section to the discharge cavity is, the smaller. Connection means could then be located ideally directly at the feed-through exit opening.

The opening is preferably a feed-through opening. By filling the discharge vessel through a feed-through opening, and then gas tight closing the feed-through opening, the thermal influence caused by the connecting process is lower than the thermal impact caused by a comparable closing process of the end closure device onto the end openings of the discharge vessel. Indeed, closing the feed through opening requires a local and very quick heating. Furthermore, thanks to the relatively high speed and local implementation of the gas tight connecting process, the coating layers used to improve the bonding between the discharge vessel and the end closure device will not be damaged.

According to the present invention, a crevice is the space between the gas tight sealed feed-through, and the part in which said feed-through is arranged and sealed. Another definition of a crevice is the remaining space of the feed-through opening, after the feed-through is arranged into said feed-through opening and gas tight sealed. More precisely, a crevice is the volume remaining from subtracting the feed-through part volume from the feed-through opening volume. From the feed-through opening volume is actually also subtracted the volume of the connection means after the feed-through connecting process has been performed.

The outer form of end closure members according to the present invention has preferably the shape of a cork, a disk, a plug or an end cap.

The end closure member has a shape fitting to the end part of the discharge vessel. Said shape depends on the location where the end closure member is mounted. The end closure member can be inserted into the end opening of the end part. In such a case, the end closure member can have the form of a plug. The end closure member can be arranged so that it contacts the end opening outer end part. In such a case, the end closure member can have the form of a disc or of an end cap. Preferably, the cap can at least partly surround the end opening outer end part. Indeed, the end closure member can be advantageously located partly inside said end opening and partly outside. In such a case, the end closure member can have the form of a cork.

The end-closure device materials should have a thermal expansion coefficient matching the one of the discharge vessel, so that no stress or crack builds up during the sealing process and the thermal cycles of operating burner later on. Thus, the end closure device, preferably end closure member and/or connection means, is made of a metal, preferably Mo, a coated metal, preferably Ta coated with Mo or Al₂O₃, a metal alloy, preferably an inter-metallic such as Mo₃Al, of a cermet, and/or of a ceramic, preferably Al₂O₃.

The end closure member through-going feed-through opening cross-section can have any suitable form; preferably said cross-section has the profile of a cone, a parabola, a hyperbola, an ellipse, a hemisphere, a Y-like profile, an O-like profile, a T-like profile or a X-like profile.

The sealant, connecting the end closure member to the coating layer, is a material comprising metal, metal alloy, and/or ceramic.

Should the end closure device be made of a cermet material, it would preferably be a functionally graded material. A suitable cermet material used according to the present invention has a substantially continuous gradient of at least compounds A and B, whereby the concentration of material compound A substantially increases in the same degree, in that the concentration of material compound B decreases. The concentration gradient can preferably be described with any linear or non-linear function.

The cermet material comprising a gradient of at least compounds A and B is characterized in that it has an outer layer, in which the concentration of material compounds A and B are constant.

Said layer can have a thickness from 0 to 500 μm, preferably from 0 to 50 μm and most preferably from 0 to 5 μm.

The compound A can be Al₂O₃ and the compound B can be Mo. Other compounds can be mixed additionally to A and B in the same graded, or in an ungraded, manner.

In a preferred embodiment of the present invention, a gas-tight high-pressure burner comprises at least one of said end closure members with at least one feed-through.

Preferably, the gas-tight high-pressure burner coated partly with at least one layer comprises at least one end closure member with at least one feed-through, preferably the end closure member has at least one through-going feed-through opening, whereby the cross-sectional area of the feed-through opening varies in longitudinal direction of the end closure member.

A further aspect of the present invention is to provide a lamp comprising said gas tight high-pressure burner. The lamp comprising said burner is preferably arranged in a headlamp. Such headlamps are preferably used in the automotive sector, especially in the car industry, but are not limited to this use only.

Another aspect of the present invention is to provide a method of manufacturing a gas tight high-pressure burner, comprising at least one end closure device, at least two feed-through parts, and at least one partly coated discharge vessel, with at least one end opening, whereby said method comprises the following steps:
i) Filling said discharge vessel with an ionisable filling through at least one opening, and
ii) Closing said opening by arranging a feed-through therein, followed by gas tight connecting said feed-through to the end closure device and/or to the discharge vessel, whereby a gas tight high-pressure burner is obtained.

These and other aspects of the invention will be apparent from and elucidated with reference to the embodiments described hereinafter.

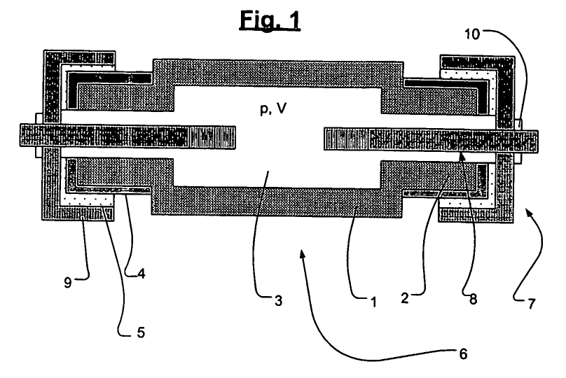

FIG. 1 shows a longitudinal cross-section of a gas-tight high-pressure burner with a series of coating layers.

FIG. 2 shows a longitudinal cross-section of a gas-tight high-pressure burner with two series of coating layers.

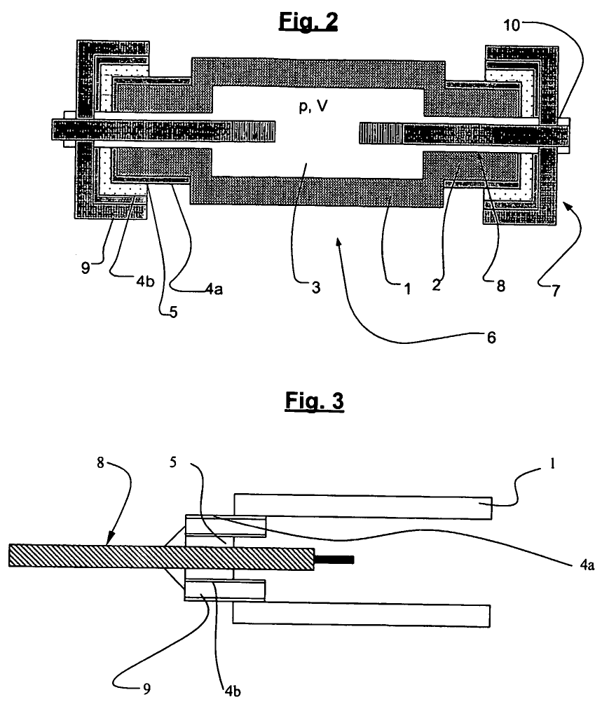

FIG. 3 shows in detail a longitudinal cross-section of a coated end plug gas tight connected to an end part.

FIG. 1 shows a discharge vessel 1 with tubular end parts 2 and a discharge cavity 3, coated by a coating layer 4. The coating layer 4 covers the surface of said tubular end parts 2. Said coating layer 4 is located between the discharge vessel 1 and a sealant 5. In order to obtain a gas-tight high-pressure burner 6, said discharge vessel 1 is closed by an end closure device 7 and a feed-through 8. The end closure device 7, gas-tight connected to the discharge vessel 1 by said sealant 5 and said coating layer 4, comprises an end closure member 9 with a feed-through opening susceptible to arrange said feed-through 8 therein. Said feed-through 8 is gas-tight connected to the end closure member 9 by connection means 10.

FIG. 2 shows a discharge vessel 1 similar to the discharge vessel previously described in FIG. 1. The discharge vessel 1 according to FIG. 2 has a first coating layer 4a and one additional second coating layer 4b. The additional second coating layer 4b is located between the end closure member 9 and the sealant 5 of the end closure device 7.

FIG. 3 shows an end closure member 9, more precisely an end plug with an end opening, gas tight connected to the discharge vessel 1 of a gas tight high-pressure burner. A feed through 8 with an electrode is arranged into the end opening of the end plug, and is gas tight sealed to said end plug by a sealant 5. The end plug is made of a cermet, preferably of a functionally graded cermet. At its outer surface, facing the discharge vessel 1, the end plug is coated with a first ceramic coating layer 4a, in order to improve its bond with said ceramic discharge vessel 1. At its inner surface, facing the sealant 5, the end plug is coated with a second metallic coating layer 4b, in order to improve its bond with said metallic sealant 5.

### LIST OF REFERENCE NUMBERS

1 Discharge vessel
2 End part
3 Discharge cavity
4 Coating layer
4a First coating layer
4b Second coating layer
5 Sealant
6 Gas-tight high-pressure burner
7 End closure device
8 Feed-through
9 End closure member
10 Connection means

1. Discharge vessel (1) with at least one end part (2) and a discharge cavity (3),
characterized in, that at least one coating layer (4) is located and gas-tight connected between an end part (2) of said discharge vessel (1) and a sealant (S) and/or between a sealant (5) and an end closure member (9).

2. Discharge vessel (1) according to claim 1, characterized in, that the gas-tight bonding of the coating layer (4) to the discharge vessel (1), to a sealant (5), and/or to an end closure member (9) is stronger compared to the direct gas-tight bonding of said sealant (5) to said end closure member (9) and/or discharge vessel (1).

3. Discharge vessel (1) according to claims 1 to 2, characterized in, that the coating layer (4) has an expansion coefficient in the range between 4·10⁻⁶ K⁻¹ and 12·10⁻⁶K⁻¹.

4. Discharge vessel (1) according to claims 1 to 3, characterized in, that the coating layer (4) is chemically resistant towards oxides and iodides.

5. Discharge vessel (1) according to claims 1 to 4, characterized in, that the coating layer (4) is of a material selected from the group comprising at least W, Mo, and/or Pt.

6. Discharge vessel (1) according to claims 1 to 5, characterized in, that the coating layer (4) covers at least the end parts (2) of the discharge vessel (1) of the end closure device (7).

7. Gas-tight high-pressure burner (6) with coating layer (4) comprising at least one discharge vessel (1) according to claims 1 to 6 and at least one end closure device (7) and at least one feed-through (8).

8. Gas-tight high-pressure burner (6) according to claim 7 comprising at least one end closure member (9) with at least one feed-through (8), preferably the end closure member (9) has at least one through-going feed-through opening, whereby the feed-through opening cross-section varies along the end closure member (9) longitudinal axis.

9. Lamp, comprising at least one gas-tight high-pressure burner (6) according to claims 7 or 8, whereby the lamp is preferably arranged in an automotive headlamp unit.

10. Method of manufacturing a gas-tight high-pressure burner (6) according to claims 7 or 8, comprising
a) at least one end closure member (9),
b) at least two feed-through members (8),
c) at least one connection means (10),
d) at least one sealant (5), and
e) at least one discharge vessel (1) with a coating layer (4), whereby the manufacturing method comprises the steps:
i) filling said discharge vessel (1) with an ionisable filling through at least one feed-through opening, and
ii) closing said feed-through opening by arranging a feed-through (8) in said opening followed by gas-tight connecting said feed-through (8) to the end closure device (7) and/or to the discharge vessel (1) with connection means, whereby a gas-tight high-pressure burner (6) is obtained.
